(19) United States
(12) Patent Application Publication
(10) Pub. No.: US 2012/0126948 A1
(43) Pub. Date: May 24, 2012

(54) IDENTIFICATION SYSTEM AND METHOD

(76) Inventor: Kevin Michael Brunski, Crown Point, IN (US)

(21) Appl. No.: 13/111,335

(22) Filed: May 19, 2011

Related U.S. Application Data
(63) Continuation-in-part of application No. 11/943,033, filed on Nov. 20, 2007.
(60) Provisional application No. 61/346,671, filed on May 20, 2010.
(60) Provisional application No. 60/866,531, filed on Nov. 20, 2006.

(51) Int. Cl. G06K 7/01

(52) U.S. Cl. 340/10.1

(57) ABSTRACT

An identification system and method by which an electronic identification transponder is attached to a dental structure within the oral cavity of a human to provide a unique personalized identification system for rapid, secure access to clinically-relevant individual-authorized emergency medical and health information records from a secure database. The transponder is adapted to be interrogated by, to be written to, and to communicate with a reader unit, and the transponder and the reader unit are adapted to communicate over a distance limited to less than ten centimeters.

### CROSS REFERENCE TO RELATED APPLICATIONS

This application claims the benefit of U.S. Provisional Application No. 61/346,671, filed May 20, 2010, the contents of which are incorporated herein by reference. In addition, this is continuation-in-part patent application of co-pending U.S. patent application Ser. No. 11/943,033, filed Nov. 20, 2007, which claims the benefit of U.S. Provisional Application No. 60/866,531, filed Nov. 20, 2006. The contents of these prior applications are incorporated herein by reference.

### BACKGROUND OF THE INVENTION

The present invention generally relates to identification systems and methods. More particularly, this invention relates to an identification system and method in which a radio frequency identification (RFID) device is placed within the oral cavity of a human to provide rapid and secure access to personal information from a secure database.

Transponders and particularly radio frequency identification (RFID) tags and microchips (hereinafter, RFID transponders) have been employed to identify products, inventory, and various other inanimate objects for purposes of tracking shipment, manufacturing, theft protection, etc. For use in product and inventory identification, RFID transponders are relatively large in size and mounted to an adhesive strip for application to the objects of interest. The RFID transponder is then interrogated with a reader unit, which causes the transponder to transmit a signal containing data stored on the transponder that uniquely identify the object. The use of RFID transponders has also found use in other scenarios, such as reuniting lost dentures with their owners in different medical venues.

More recently, RFID transponders have been used to identify living beings, including pets, livestock, etc., for purposes of determining ownership. For use in animals, RFID transponders are typically encapsulated in a biologically inert casing and placed beneath the skin by injection. Such RFID transponders are typically small, such as about 11 mm in length and about 3 mm in diameter, and can be coded with up to nine digits to uniquely identify the animal. A commercial example of such an RFID transponder is sold under the name Avid® by Avid Marketing, Inc. Because RFID transponders have the undesirable potential to migrate, cause foreign body tissue reactions, and use an invasive placement or surgical removal procedure when implanted subdermally, their use in humans has not been widely accepted or practiced. However, if RFID transponders could be securely placed in a manner that eliminates such issues, their use in human identification might become more widely practiced.

Electronic medical records (EMR) are becoming more prevalent across the world. Any section of information that pertains to a patient's health, including but not limited to a doctor's diagnosis, treatment options, insurance information and radiographs may be recorded and stored for later retrieval through the use of emerging EMR systems. Patients can also choose to keep their own records digitally through the use of a patient health record (PHR), a commercial example of such is sold under the name MedFlash® by Connectyx Inc. The use of a PHR allows individuals to expand their records, for example, by keeping a more extensive family medical history or recording emergency medical information on a portable flash (thumb) drive or internet portal. Access is typically via a USB connection or the Internet by simple password protection or name recognition. However, identification information to a PHR portal has the undesirable potential of password theft, as well as being unaccessible at a time of need, for example, if the individual is unconscious or otherwise unable to communicate.

Notwithstanding the above, it would be desirable to provide a human identification capability that could be linked to an individual's PHR and ultimately used as a unique patient identifier, enabling communication between various PHR and EMR services on the market today. Such a capability could also enable the use of a unique access code for EMR vaults that are currently in their infancy. Such capabilities would be particularly advantageous for use by children, the elderly, and others whose age, mental capacity, and/or other physical and medical status puts them at risk of being lost, abducted or in immediate need of their medical information by first responders in an emergency situation. Members of the armed services and others whose jobs put them at risk of being injured could also benefit from having rapid access to their medical records.

Increased regulation on traceability of dental prostheses, combined with the opportunity to provide an immediate personalized clinical profile to select healthcare providers, provides additional scenarios where a cost-effective, automated and user friendly solutions would be desirable to help identify and trace dentures and provide a personalized identification system to access patient-authorized clinically-relevant health information stored in secure databases and link together different PHR/EMR systems.

### BRIEF DESCRIPTION OF THE INVENTION

The present invention provides an identification system and method by which an electronic identification transponder is placed within the oral cavity of a human to provide a unique personalized identification system for rapid, secure access to clinically-relevant patient-authorized emergency medical and health information records from a secure database.

According to a first aspect of the invention, information regarding or relating to an individual is accessed with an electronic identification transponder adapted to be interrogated by, to be written to, and to communicate with a reader unit. The electronic identification transponder and the reader unit are adapted to communicate over a distance limited to less than ten centimeters. The electronic identification transponder is attached to a dental structure within an oral cavity of the human. The dental structure may be a mammalian tooth, denture, removable partial denture, athletic mouth-guard, crown or bridge.

According to a preferred aspect of the invention, the system and method involve a technique for the preparation and placement of an electronic identification transponder within the oral cavity of an individual, and the use of an identification code stored on the transponder to enable access to a individual's personal health record (PHR). The identification code can be, for example, a sixteen-digit code unique to a single individual, and the transponder can be placed on or within a tooth, denture crown, bridge, athletic mouth guard or various other removable or fixed dental prostheses or appliances that can be placed within the oral cavity.

According to another preferred aspect of the invention, the identification code is only readable with a reader unit placed in close proximity to the transponder, so that the transponder cannot be surreptitiously accessed under most circumstances, yet individual-authorized emergency medical and health information records can be accessed from a secure database even in medical emergencies in which the individual is unable to assist. As such, when placed within the oral cavity of an individual, the unique identification code of the transponder can serve as a unique patient identifier that remains constant with the individual, can speak for them when they are unable, and can be used to unlock portable and medical record vaults, which is currently a missing link between individuals and their PHR/EMR.

In view of the above, the present invention provides a secure, noninvasive, and confidential method for instantaneously retrieving identification and potentially other information concerning a person into which the transponder is implanted. Such information can be vital to identify persons in a variety of emergency and nonemergency situations. Furthermore, the transponder can be present without visual detection by uninformed parties, such that unauthorized removal of the transponder is not likely to occur. Finally, the transponder can be permanent if so chosen, yet removable by a skilled technician without causing pain or permanently disfiguring the individual. Placement and operation of RFID transponders of this invention have been validated in removable dental prosthetics, fixed dental prosthetics, and human teeth.

Other aspects and advantages of this invention will be better appreciated from the following detailed description.

### BRIEF DESCRIPTION OF THE DRAWINGS

FIGS. 1A through 1E schematically depict human Tooth #30 (facial aspect) and a procedure for placing a transponder in Tooth #30 in accordance with an embodiment of this invention.

FIGS. 2A through 2F schematically depict human Tooth #3 (lingual aspect) and a procedure for placing a transponder in Tooth #3 in accordance with an embodiment of this invention.

FIGS. 3A through 3E schematically depict human Tooth #31 (facial aspect) and a procedure for placing a transponder in Tooth #31 in accordance with an embodiment of this invention.

FIGS. 4A through 4E schematically depict human Tooth #2 (lingual aspect) and a procedure for placing a transponder in Tooth #2 in accordance with an embodiment of this invention.

FIG. 5 schematically represents a scanner suitable for intra-oral interrogation of the transponders placed as shown in FIGS. 1A-1E, 2A-2E, 3A-3E, and 4A-4E.

FIG. 6 schematically represents a scanner suitable for extra-oral interrogation of the transponders placed as shown in FIGS. 1A-1E, 2A-2E, 3A-3E, and 4A-4E.

FIG. 7 schematically represents an implantable RFID transponder suitable for use as the transponder for the present invention.

FIGS. 8 and 9 schematically depict the placement of a transponder on human permanent (adult) and primary (child) mandibular canines in accordance with embodiments of this invention.

FIG. 10 schematically depicts the placement of a transponder on human primary Tooth J or Tooth K in accordance with an embodiment of this invention.

FIGS. 11A through 11D, 12A and 12B schematically depict the placement of a transponder on dentures in accordance with embodiments of this invention.

### DETAILED DESCRIPTION OF THE INVENTION

The present invention makes use of RFID transponders that are sufficiently small and biologically inert to permit their attachment to or implantation in a human dental structure, with preferred implantation locations being intra-coronally on certain human teeth, crowns and bridges and preferred attachment locations being extra-coronally on human teeth and removable and fixed dental prosthetics, including but not limited to dentures, removable partial dentures, orthodontic retainers and athletic mouth guards. Placement on dental structures is particularly selected to facilitate attachment or implantation, be accessible for interrogation and communication with a separate reader unit, and reduce the risk that the transponder will be damaged or interfere with the bearer's normal behavior. For this purpose, the transponder is preferably not larger than about one millimeter in width by about six millimeters in length, and is carried in or on a pliable or rigid substrate, for example, a biologically inert glass or resin. When attached or implanted in the oral cavity, the transponder is preferably encased in a strong biocompatible glass or resin so that the transponder does not contact body tissues and will remain fixed, thus eliminating the possibility of an allergic reaction or rejection by body tissues.

Preferably, once placed the transponder is registered to the particular individual by entering or registering a personalized multi-digit (e.g., sixteen digit) identification code. The identification code is preferably encrypted and cannot be altered or removed once associated with the transponder. The transponder can also be encoded to provide certain information concerning the individual, such as the individual's medical history. As an example, the identification code could be or include the individual's social security number, and may contain data that contains portions of the individual's medical history, such as critical medical information that a first responder would require in a life saving emergency situation, including but is not limited to allergies and current medication information. More preferably, the identification code is associated with a secure database that contains portions or all of the individual's medical history. The transponder can be scanned by the reader unit, which is preferably adapted to interrogate the transponder and, optionally, program the transponder. According to a preferred aspect of the invention, the transponder is readable by only a specific reader so as to reduce the likelihood of an unauthorized interrogation or write attempt. Another preferred aspect of the invention is that communication between the transponder and reader unit is very limited in distance, for example, less than 10 cm and preferably not more than 3 cm, so that the individual (if conscious) will be aware of the presence of the reader unit, thereby reducing the risk of surreptitious attempts to access data through the transponder. The communication process is further secured by the duration over which communication between the transponder and reader unit must take place, for example, about 5 to 15 seconds, which further insures individual awareness of any unauthorized attempt to read the transponder.

Preferred transponders do not contain any moving parts, and when read or written to do not emit heat, vibration, or any other potential source of sensation felt by the individual. A preferred transponder is an ultrahigh frequency (UHF) RFID transponder or chip (microchip), such as an RFID tag commercially available from Lutronic International under the name NONATEC®. According to Lutronic International literature, the NONATEC® tag utilizes an electronic chip from Philips Research. In contrast to conventional silicon-chip-based RFID tags, the Philips chip is understood to be a fully functional RFID chip that operates at a frequency approved by the FCC (13.56 MHz) and is compatible with FDA standards. The Philips chip is printed directly onto a plastic substrate along with an antenna. For illustrative purposes, FIG. 7 represents such a chip 12 printed on a plastic substrate 14 with an antenna 16, all of which are encapsulated on the substrate 14 to form an RFID transponder 10. In addition to being very small, generally on the order of about one millimeter in diameter and about five to six millimeters in length when encapsulated with glass or resin, the NONATEC® RFID tag is capable of recognizing up to 512 characters (bytes), and is therefore well suited for not only storing a personalized multi-digit identification code, but also store additional information concerning an individual, such as the individual's critical medical information, as well as providing an access code that enables the individual's personal health record (PHR) to be accessed.

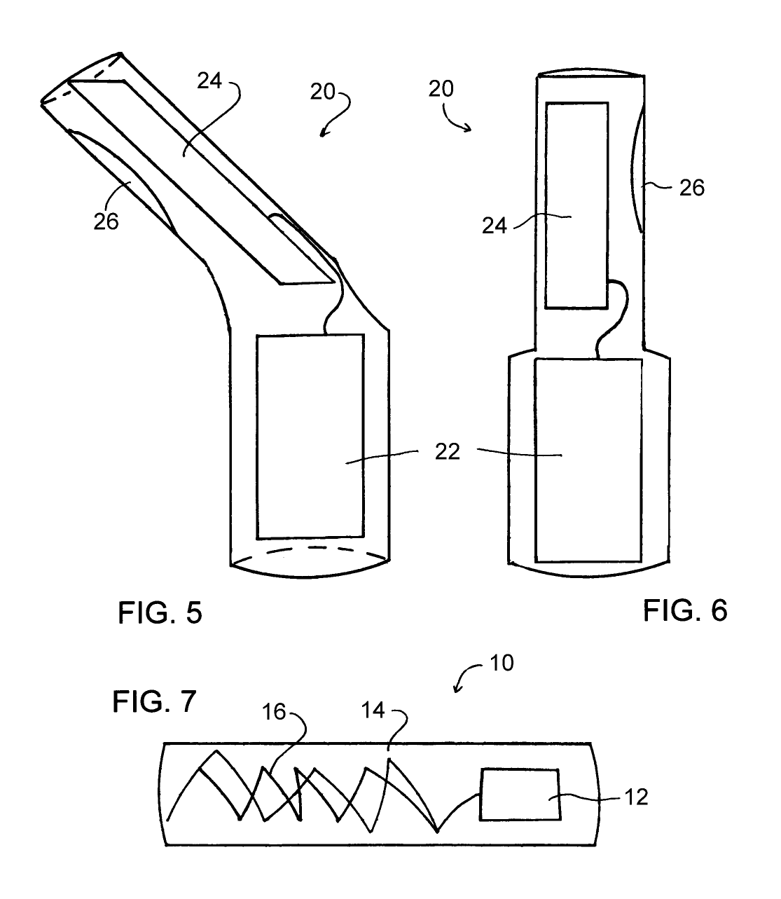

The transponder 10 is not required to be self-powered, and therefore does not contain any internal power supply that would require periodic replacement. Instead, the transponder 10 is preferably passive, meaning that the transponder 10 is capable of transmitting and receiving data only when interrogated by the reader unit. Intra-oral and extra-oral reader units 20 are schematically represented in FIGS. 5 and 6. Each reader unit 20 is represented as being equipped with an RFID transceiver 22, circuitry 24, and a readout 26 that displays the identification code of the transponder 10 when interrogated with the reader unit 20. Interrogation can be initiated with a low energy radio signal emitted from the reader units 20 that energizes the transponder to transmit its unique identification code in an FCC approved range, for example, about 10 to about 14 MHz. The reader units 20 can be equipped with an internal battery, and/or can be powered by being plugged into a computer (such as through a USB port) or other power source. Commercial examples of suitable reader units that also have a programming capability include those available under the name NONATEC® from Lutronic International. A handheld version is referred to as the NONATEC® Reader/Writer Device, while a hands-free bench-mounted version is referred to as the NONATEC® BLUETOOTH® Lab Bench Reader/Writer Device. Both reader units operate at about 13.56 MHz, and are capable of reading and writing to RFID plastic cards and RFID tags containing 512 bytes of information. The reader units fulfil FCC and General Guidance Regulations on hospital equipment interference and Medical Electrical Safety. The communication distances of both reader units are measured in centimeters, with a minimum distance of about 0.5 cm and a maximum distance of 3 cm to promote security. The reader units are also adapted to transmit data via a standard RS-232 interface or the like to a computer that supports custom applications and preferably has BLUETOOTH® capabilities. The handheld version further has manual, remote and computer-controlled operational capabilities. Furthermore, both units come with software that facilitates the programming and interrogation of the transponders, including transponder identification, data retrieval and data writing, as well as categories of information stored on the transponders or associated with the transponder identification code. The units also confirm BLUETOOTH® capability to transfer said identification code to a laptop or smart phone to access a PHR thus eliminating human input errors.

In investigations leading up to this invention, the NONATEC® transponders and reader/writer units noted above were shown to perform well for the intended application, including the capability of interrogation and communication when the reader/writer unit was placed immediately adjacent to the external surface of an individual's cheek, such that the communication distance was within the 0.5 to 3 cm operational range of the units. Nonetheless, it is foreseeable that other transponders and reader/writer units could be used, as long as the aforementioned communication distance limitation is provided. However, as reported in U.S. Pat. No. 6,734,795, communication distances of various commercially-available RFID tags, for example, the Avid® RFID tag sold by Avid Marketing, Inc., far exceed the prescribed distance for the RFID transponder 10 of this invention. Finally, it is foreseeable that various functionalities could be incorporated into the transponder 10, including a global positioning system (GPS) capability and increased storage capacity as technology progresses.

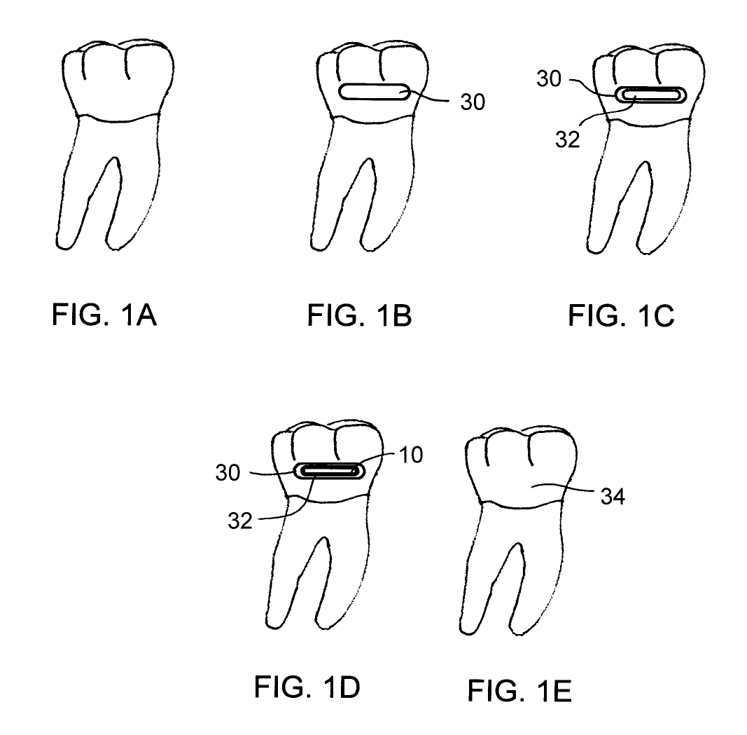

While the NONATEC® RFID tag is adapted to be placed subdermally in animals by injection; the present invention places the transponder 10 in the human oral cavity, such as in or on a mammalian tooth as schematically represented in FIGS. 1A-1E, 2A-2E, 3A-3E, 4A-4E, and 8-10. A key aspect of the system invention is the ability to place a transponder in a location that is unobtrusive, visually undetectable, permanent (if so chosen), yet removable by a skilled technician without causing pain or permanently disfiguring the individual. Based on these criteria the present invention proposes the placement of the transponder 10 in prioritized sites implanted in certain teeth by a specific technique so as not to cause irreversible damage to the transponder 10. Such locations are identified herein in reference to tooth locations in accordance with the Universal Tooth Numbering System, a dental notation system commonly used in the United States and elsewhere.

According to the site prioritization proposed by this invention, a suitable location for implanting the transponder 10 is the buccal pit in the facial surface of Tooth #30 (right lower first molar), as well as the buccal pit on the facial surface of Tooth #19 (left lower first molar). The buccal pit of Tooth #30 and Tooth #19 are desirable locations because each bears an inherent enamel defect and uncoalesced enamel, which is commonly filled as a preventative measure to ward off the development of a dental cavity. Other prioritized sites of this invention include the lingual groove in the lingual surface of Tooth #3 (right upper first molar) or Tooth #14 (left upper first molar), which also bear an inherent enamel defect and uncoalesced enamel. Still other prioritized sites include the facial surface of Tooth #31 (right lower second molar) or Tooth #18 (left lower second molar), and the lingual surface of Tooth #2 (right upper second molar) or Tooth #15 (left upper second molar). Other possible sites include the lingual and occlusal surfaces of Tooth #30 or #19, the occlusal surface of Tooth #31 or #18, and the facial and occlusal surfaces of Tooth #15 or #2.

FIGS. 1A through 1E represent facial views showing steps of a procedure for implanting the transponder 10 in the buccal pit of Tooth #30. As noted above, the buccal pit of Tooth #30 is the primary location, with the buccal pit of Tooth #19 being an alternative primary location if implantation in Tooth #30 is not possible. Those skilled in the art of dentistry will be aware that the presentation and steps for implantation in Tooth #19 would be the mirror image of that shown in FIGS. 1A-1E.

FIG. 1A represents Tooth #30 prior to placement of the transponder 10. In FIG. 1B, the tooth has been prepared for implantation by creating a cavitation 30 at the buccal pit of the tooth. The cavitation 30 can be formed using standard dentistry procedures, and therefore will not be discussed in any detail here. Suitable dimensions for the cavitation 30 are a length (mesial-distal) of up to 7 mm (preferably 5 to 7 mm), a width (occlusal-cervical) of up to 2 mm, and a depth (pulpally) of up to 4 mm (preferably 2 to 4 mm). With these dimensions, tooth preparation can be completed with or without anesthetization. The horizontal orientation of the cavitation 30 is preferred. A vertical orientation using the same cavitation dimensions could be used, though doing so is not preferred or recommended. The enamel margins of the cavitation 30 are preferably beveled, such as by using a carbide or diamond bur. Preparation is best completed by conventional equipment such as a high-speed handpiece (air or electric driven) and a 330 and 57 carbide bur, but air abrasion, waterlase, and dental laser are also options.

Following rinsing and drying to remove debris, a standard acid etch and bond is performed. Any conventional acid etch and bond technique can be used, though a one-component light-cured self-etched/self-priming dental adhesive is preferred. Alternatively, a separate etch and bond could be performed, in which case it is necessary that all etchant is remove by a water rinse. Suitable self-etching/self-bonding dental adhesives are known to contain mono-, di- or trimethacrylate resins, dipenta-crythritol penta acrylate monophosphate, photo-initiators, stabilizers, water acetone, and cetyl amine hydrofluoride. All tooth surfaces are preferably scrubbed with generous amounts of the adhesive for about fifteen to twenty seconds to thoroughly wet all tooth surfaces. This procedure is then repeated, after which excess adhesive is removed and the remainder dried for about five to ten seconds with clean dry air. Cure can then be accomplished by subjecting the adhesive to light for about ten seconds.

If a separate etch and bond technique is used, the etchant may contain a phosphoric acid concentration of 35 to 50% in solution or gel. A treatment of about thirty to sixty seconds is appropriate, followed by rinsing and drying without dessication for about fifteen seconds. The bonding agent preferably contains a sulfur-based amine activator within an ethyl alcohol solvent. The use of a hydrochloric or hydrofluoric acid etch is not recommended due to the risk that the transponder 10 might be attacked by these acids at high concentrations.

FIG. 1C depicts the result of placing a bed 32 of flowable resin in the cavitation 30, for example, to a depth of about 0.5 to about 1 mm. A suitable resin material is a light-curable microfill resin paste containing BIS-GMA polymerizable dimethacrylic resin, strontium or barium aluminum fluorosilicate glass, low dispersed silica, ammonium salt of dipentaerythitol penta-acrylate phosphate and mixed oxide conventional catalysts and stabilizers. FIG. 1D shows the placement of the transponder 10 on the resin bed 32, after which the resin bed 32 undergoes curing for a duration sufficient to fully set the resin. The bed 32 of flowable resin is placed to not only secure the transponder 10, but to ensure the dental pulp is insulated and protected. The bonded flowable resin bed 32 also ensures the dentinal tubules are completely sealed, ensuring that the transponder 10 is ultimately imbedded in resin and does not intimately contact the tooth.

FIG. 1E shows the completed Tooth #30 after filling with a dental restoration 34 formed with a posterior composite resin to close the cavitation 30 and the transponder 10 therein. The composite resin is preferably a delicate, void-free microfill (small particulate size) composite resin containing a pyrogenic silica filler with a particle size of less than one micrometer, such as on the order of about 0.04 micrometer. A microfill posterior composite resin is preferred for final filling of the cavitation 30 because it's condensation ability allows for the application of a firm pressure to deliver the resin totally around the exposed portion of the transponder 10, as well as to conform to all regions of the cavitation 30. Microfill posterior composite resins are preferred over traditional macrofill (large particulate size) posterior composite resins because the latter contain filler particles such as quartz or boron glass with a particle size on the order of about 1 to 20 micrometers. Though it may be possible to condense into the cavitation 30, macrofill composite resins increase the chance of internal voids in the vicinity of the transponder 10, and lower polishability. Due to the inherent nature of shrinkage of dental resins, it will typically be important to follow a protocol of the type described above, involving an incremental build-up of resin around the transponder 10 so as not to fracture nor destroy the transponder 10 during curing of the resin.

The composite resin undergoes curing until a full set is confirmed, after which the restoration 34 is polished. Armamentarium for finishing the final restoration 34 includes fine grit diamond, 12 to 20 bladed carbide burs, tapered or round stones, finishing strips and disks, rubber cups and a resin glaze.

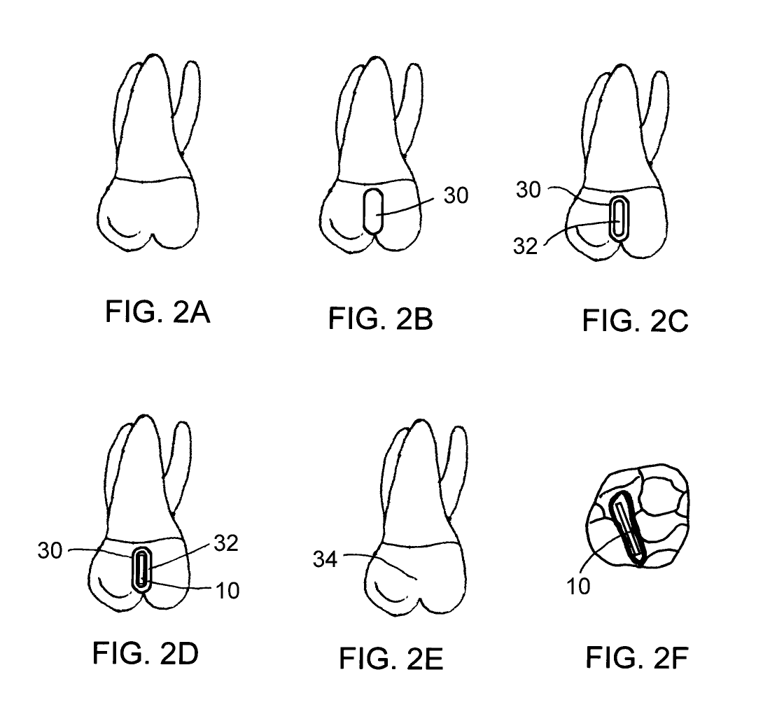

FIGS. 2A through 2E represent lingual views showing the procedure for implanting the transponder 10 in the secondary location, namely, the lingual groove of Tooth #3. (The presentation and steps for implantation in alternative secondary location Tooth #14 would be the mirror image of that shown in FIGS. 2A-2E.) Other than the cavitation 30 being vertically oriented as represented in FIG. 2B, the procedure is essentially identical to that explained above for Tooth #30 and #19 in reference to FIGS. 1A-1E. For clarity, FIG. 2F is an occlusal (top) view of the implanted transponder 10 in Tooth #3.

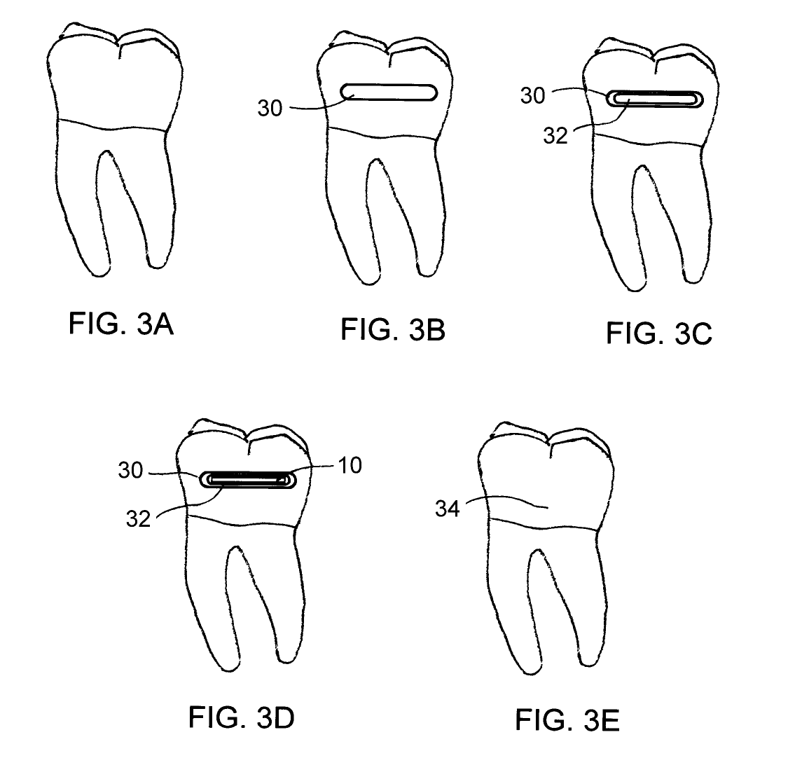

FIGS. 3A through 3E represent facial views showing the procedure for implanting the transponder 10 in the tertiary location, namely, the facial surface of Tooth #31. (The presentation and steps for implantation in alternative tertiary location Tooth #18 would be the mirror image of that shown in FIGS. 3A-3E.) The procedure is essentially identical to that explained above for Tooth #30 and #19.

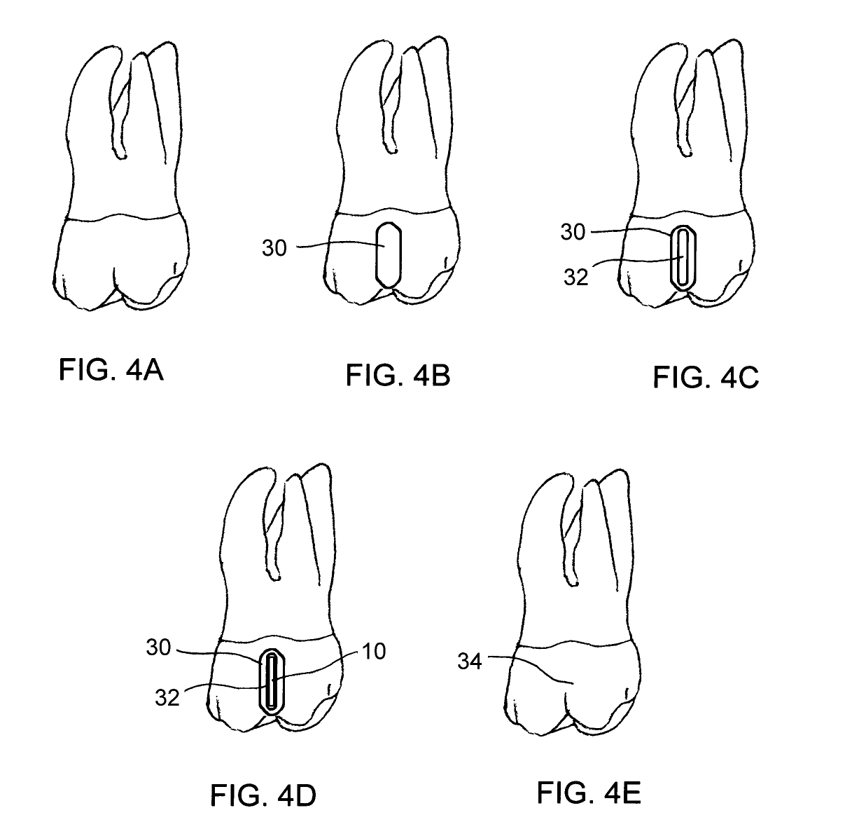

FIGS. 4A through 4E represent lingual views showing the procedure for implanting the transponder 10 in the quaternary location, namely, the lingual surface of Tooth #2. (The presentation and steps for implantation in alternative secondary location Tooth #15 would be the mirror image of that shown in FIGS. 2A-2E.) Other than the cavitation 30 being vertically oriented as represented in FIG. 4B, the procedure is essentially identical to that explained above for Tooth #30 and #19.

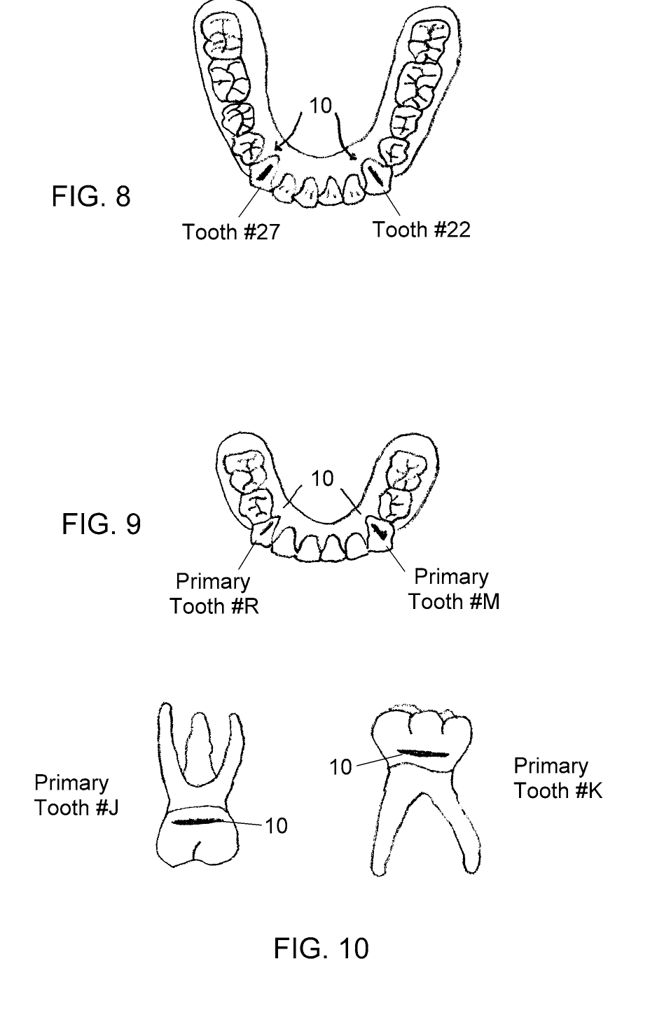

The transponder 10 can also be bonded directly to the external tooth enamel of the tooth, instead of being implanted beneath the tooth surface. Acceptable locations for this technique are represented in FIGS. 8 through 10. FIG. 8 represents preferred locations in permanent (adult) dentition as the lingual surface of Tooth #22, and secondarily the lingual surface of Tooth #27. Alternative permanent dentition locations include the lingual surface of Tooth #19 and if absent the lingual surface of Tooth #30, the lingual surface of the mandibular central incisors and if absent the mandibular lateral incisors, and the facial surface of Tooth #3 and if absent Tooth #14. If esthetics disallow Teeth #3 and #14, the transponder 10 can be attached to Tooth #2 and if absent Tooth #15.

FIG. 9 represents preferred locations in primary (child) dentition as the lingual surface of Tooth #M, and secondarily the lingual surface of Tooth #R. As represented in FIG. 10, alternative primary dentition locations include the cervical third of the facial surface of tooth #K and, if absent, Tooth #T, and the cervical third of the facial surface of tooth #J and, if absent, Tooth #A. Other locations include the occlusal and facial surfaces of Tooth #S or Tooth #L, the occlusal, lingual groove or facial surfaces of Tooth #B or Tooth #1, the occlusal surface of Tooth #T or Tooth #K, and the occlusal or lingual groove surface of Tooth #A or Tooth #J.

Prior to attachment directly to the external tooth enamel, the selected tooth location can be conditioned by a pumice slurry or air abrasion to remove plaque and/or pellical layer, and scaling can be performed to remove calculus if needed. Rubber dam isolation is highly recommended. After testing the transponder 10 by interrogation with the reader unit, a 0.5 mm-deep retention groove may be formed in the external tooth enamel of the tooth to eliminate over-contouring and resist rotational forces. Enamelplasty is then preferably performed using air abrasion or rotary burs. The selected site is then washed with copious amounts of water and dried without desiccation. Once the attachment surface has been treated, it should remain uncontaminated, and if contamination occurs (for example, salivary contamination), the cleaning procedure should be repeated.

Attachment of the transponder 10 to the tooth is preferably performed with a one-component light-cured self-etching dental adhesive, for example, a commercial product such as Xeno IV. The adhesive is applied and the surface to which the transponder 10 is to be bonded is scrubbed for about fifteen seconds to thoroughly wet the surface. Adhesive application and scrubbing is then repeated, after which any excess solvent is removed by gently drying with clean, dry air from a dental syringe, preferably for at least five seconds. The surface should have a uniform glossy appearance with no excessive adhesive thickness or pooling and, if not, the application and air drying steps should be repeated.

The adhesive should then undergo curing by treating the tooth surface to a curing light for about ten seconds, after which a drop of flowable resin is applied immediately prior to placement of the transponder 10. If attached to a canine tooth (Tooth #22 or #27), placement of the transponder 10 is preferably vertical or perpendicular to the incisal plane and within the cingulum. The transponder 10 should not be placed on the prominent cingulum ledge, as this would promote over contouring of the restoration. Placement is the same if attaching the transponder 10 to the mandibular central or lateral incisors. If attached to a maxillary or mandibular molar site, the transponder 10 is preferably placed in horizontal or parallel to the incisal plane, whether the site is facial or lingual.

Following placement, the adhesive undergoes further curing with light, for example, with an exposure of about ten seconds. A posterior composite resin, for example, a commercial product known as HELIOMOLAR®, is then applied to completely encapsulate the transponder 10 without over-contouring the final restoration. A light cure for about ten seconds is then performed, followed by a second application and curing of the posterior composite resin. The transponder 10 is preferably covered to a thickness of about 2 mm of the resin. The restoration may be finished using a resin finishing bur and polished if the restoration is substantially over-contoured.

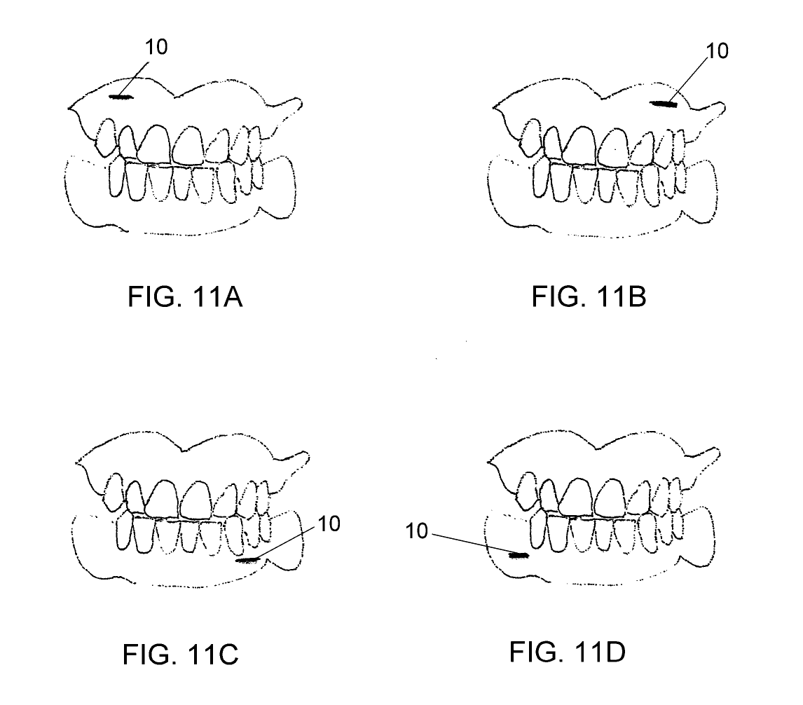

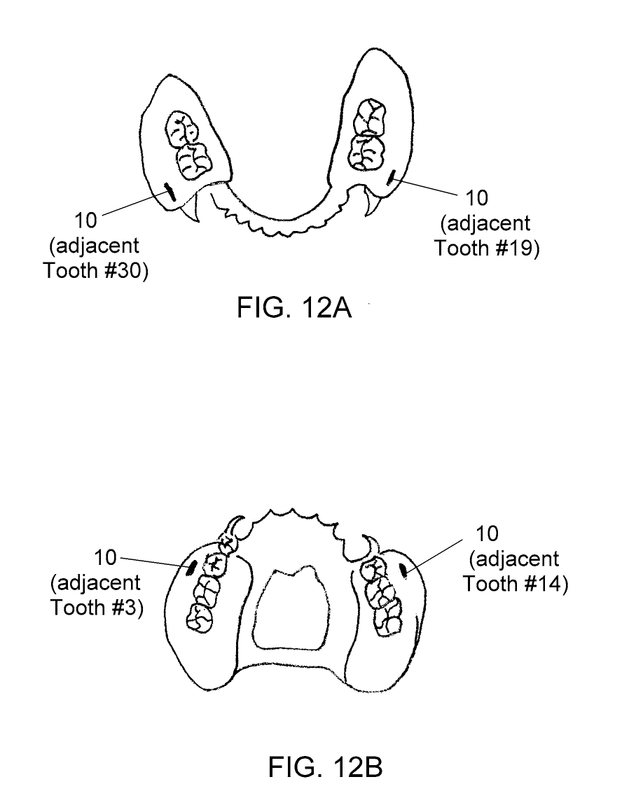

The transponder 10 can also be placed in complete or partial dentures, as represented in FIGS. 11 and 12. For example, a surface region of the prosthetic material (typically an acrylic) can be removed with a round bur or other suitable tool at one of the locations indicated in FIGS. 11 and 12. The preparation or groove for placing the transponder 10 equipped with the NONATEC® transponder is preferably about 6 mm deep, about 4 mm wide, and about 10 mm long. The preparation margins are beveled at a 45-degree angle with a course titanium acrylic bur. The resulting cavitation is then cleaned, rinsed, dried, and conditioned to accept new acrylic. After activation of the transponder 10 is verified with a reader unit, at least the mesial and distal ends of the transponder 10 are tacked into place within the cavitation using an adhesive, such as a cold-cure (room temperature curable) resin. In a preferred example, a bed of acrylic (for example, 2 mm thick) is applied to the cavitation, and then the transponder 10 is placed into the viscid bed of acrylic and firmly fixed into place with pressure so that about 0.5 mm of the applied acrylic flows around the edges of the transponder 10. Thereafter, the remaining cavitation is slowly over-filled with acrylic using a condensation salt and pepper technique, and then allowed to cure/harden. The acrylic is then polished after curing. Because polymerization at room temperature may cause shrinkage of acrylics, for example p-methyl methacrylate, preferred acrylics may contain additives, for example, N, N-dimethylm-p-toluidine or benzoyl peroxide plus dibutyl phthalate, which significantly reduce shrinkage and therefore reduce the risk of damage to the transponder 10 from contraction.

In addition to surface regions of the acrylic prosthetic material of a denture, the transponder 10 can also be directly placed within a porcelain or metallic portion of a denture, such as a tooth or retainer of a complete or partial denture. Examples of suitable locations include facial surface regions interproximal of Teeth #6-7, Teeth #10-11, Teeth #21-22, and Teeth #27-28. If a removable partial denture that replaces only posterior teeth, preferred locations are apical to the mesial root of Tooth #30, mesial root Tooth #19, apical to the mesial-buccal root Tooth #14, and mesial-buccal root Tooth #3.

The transponder can also be placed in athletic mouth guards, in which case preferred locations are facial surface regions interproximal of Teeth #6-7 for a maxillary guard and interproximal of Teeth #27-28 for a mandibular guard.

The transponder 10 can be programmed before or after placement. As previously noted, programming generally entails storing on the transponder 10 a unique identification code, and preferably coding associated with other pertinent information, such as any critical emergency medical information. Once programmed and placed in accordance with one of the forgoing implantation procedures, the functionality of the transponder 10 should be confirmed with a reader unit. The identification code associated with the transponder 10 and other pertinent information can then be downloaded for storage in a secure database, for example, in a computer with software with which the reader unit communicates, such as through a USB port or BLUETOOTH® technology that allows errorless transfer to a laptop or smart phone, which preferably accesses the Internet utilizing the identification code to enable individual-approved access to the individual's critical medical history.

Depending on the circumstances, the individual may be provided with a printout of their medical records (PHR) for informational purposes, such as updating medical histories recorded in a secure database (PHR/EMR) and/or a flash drive. The individual may also be provided with a printout of the contents of their PHR after the reader unit has recognized the identification code of the RFID transponder 10 and has sent (for example, via BLUETOOTH® technology) the code to a medical/dental office computer or smart phone to allow access the individual's PHR via the Internet. The PHR may be supplied to the medical/dental office as a printout or entered into an EMR database. The individual's PHR may also be accessed by a first responder or hospital emergency department, depending on the purpose of the implantation. The individual's PHR may be included in a database accessible by only certain individuals, such as law enforcement, healthcare providers, and particularly dentistry professionals who in the normal course of a dental examination can verify the identity of an individual, including whether a child/adult individual is listed in a missing child database or attached to the AMBER Alert or Silver Alert systems for dementia/Alzheimer. Other capabilities and uses include but are not limited to identifying military personnel, confirming an individual's identity at military facilities, accessing military PHR on the battlefield, airport security checks and customs, etc.

Increased regulation on the traceability of dental devices and prosthetics can also utilize the RFID transponder 10 to securely hold information such as the manufacturing process of a crown or bridge, including but not limited to site fabrication, country of origin, materials used, dentist, etc. The individual or dentist may then receive a smartcard with the information downloaded to it or simply utilize the implanted/embedded RFID transponder 10 and reader unit for secure access.

Once correctly placed by a dental professional, the transponder 10 will not migrate and cannot be altered or lost, nor can the transponder 10 be readily detected without appropriate equipment capable of communicating with or otherwise sensing the transponder 10. For example, an individual can be equipped with the transponder 10 without the telltale bump associated with a subdermally implanted RFID chip. An additional feature of the invention is the ability to remove the transponder 10 without injuring or scarring the individual. For example, if the individual is a child, he or she may choose to remove the transponder 10 once he or she reaches adulthood. Likewise, if the individual is a military personnel, the transponder 10 may be removed once he or she is discharged from military service. The transponder 10 can generally be removed with a round bur or any other suitable dental tool, and the resulting cavitation repaired by restoration procedures commonly used in dentistry practices.

While the invention has been described in terms of specific embodiments, it is apparent that other forms could be adopted by one skilled in the art. For example, the physical configuration of the transponder 10 could differ from that described, and a wide variety of dentistry materials and procedures are known by dentistry professionals and could be used in place of for those materials and procedures noted. Therefore, the scope of the invention is to be limited only by the following claims.

1. A method of accessing information of a human with an electronic identification transponder adapted to be interrogated by, to be written to, and to communicate with a reader unit, the method comprising attaching the electronic identification transponder to a dental structure within an oral cavity of the human, the dental structure being chosen from the group consisting of mammalian teeth, dentures, removable partial dentures, athletic mouth-guards, crowns and bridges, the electronic identification transponder and the reader unit being adapted to communicate over a distance limited to less than ten centimeters.

2. The method according to claim 1, wherein the electronic identification transponder is a radio frequency identification (RFID) transponder.

3. The method according to claim 2, wherein the RFID transponder has a programmed/encrypted multi-digit identification code uniquely associated therewith.

4. The method according to claim 1, wherein the electronic identification transponder is completely encased in a biocompatible glass or resin.

5. The method according to claim 1, wherein the electronic identification transponder is passive.

6. The method according to claim 1, wherein the dental structure is a mammalian tooth.

7. The method according to claim 6, the method further comprising forming a cavitation in the tooth, placing a flowable resin in the cavitation, placing the electronic identification transponder in the flowable resin within the cavitation, and filling the cavitation to restore the original outer appearance of the tooth.

8. The method according to claim 6, the method further comprising bonding the electronic identification transponder directly to the external tooth enamel of the tooth.

9. The method according to claim 8, the method further comprising conditioning a surface region of the external tooth enamel with a chemical etchant, placing a bed of resin on the surface region, placing the electronic identification transponder in the resin, and covering the electronic identification transponder with a second resin.

10. The method according to claim 8, the method further comprising forming a retention groove in the external tooth enamel, wherein the retention groove is covered by the electronic identification transponder and enables the electronic identification transponder to resist rotational forces.

11. The method according to claim 6, wherein the electronic identification transponder is attached to a facial, lingual or occlusal surface of the tooth.

12. The method according to claim 6, wherein electronic identification transponder is attached to a facial/buccal pit of the tooth.

13. The method according to claim 6, wherein the electronic identification transponder is attached to a lingual groove of a lingual surface of the tooth.

14. The method according to claim 6, wherein the electronic identification transponder is attached to a facial, lingual or occlusal surface of the tooth.

15. The method according to claim 1, wherein the dental structure is a removable dental prosthesis, and the method further comprises forming a cavitation in the dental prosthesis, placing a bed of acrylic in the cavitation, placing the electronic identification transponder in the acrylic within the cavitation, and filling the cavitation to restore the original outer appearance of the dental prosthesis.

16. The method according to claim 1, wherein the dental structure is a fixed dental prosthesis, and the method further comprises implanting the electronic identification transponder within a tooth of the dental prosthesis, or implanting the electronic identification transponder within a region of the dental prosthesis other than a tooth of the dental prosthesis, or directly bonding the electronic identification transponder to a surface of a tooth of the dental prosthesis.

17. The method according to claim 1, the method further comprising using the reader unit to interrogate and communicate with the electronic identification transponder and access medical records of the human.

18. The method according to claim 17, the method further comprising generating a radio signal with the reader unit to energize the electronic identification transponder and cause the electronic identification transponder to transmit the identification code at a frequency within a range of about 10 to about 14 MHz.

19. The method according to claim 18, wherein the reader unit is placed against a cheek of the human during the generating of the radio signal.

20. The method according to claim 18, wherein the reader unit is placed within the oral cavity of the human during the generating of the radio signal.

21. An identification system comprising the electronic identification transponder and the reader unit of claim 1.
